(19) United States
(12) Patent Application Publication
(10) Pub. No.: US 2009/0147937 A1
(43) Pub. Date: Jun. 11, 2009

(54) System and method for personalized call treatment by using a combination of communication and data services

(75) Inventors: Neeraj Sullhan, Mohali (IN); Ripan Kumar, Ludhiana (IN); Taranjit Singh, Mohali (IN)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Infosys Technologies Ltd., Bangalore (IN)

(21) Appl. No.: 12/288,726

(22) Filed: Oct. 22, 2008

(30) Foreign Application Priority Data
Oct. 23, 2007 (IN) 2399/CHE/2007

(51) Int. Cl. H04M 3/42

(52) U.S. Cl. 379/201.02

(57) ABSTRACT

A system and method for providing personalized call treatment to an incoming call by using a combination of data and communication services is provided. The system comprises a Mashup application for determining a treatment method corresponding to each incoming call based on a called person's profile and one or more predefined rules. The system also comprises a communication services platform and a data services platform coupled with the Mashup application.

### BACKGROUND OF THE INVENTION

The present invention relates to call treatment methods and systems by utilizing personal information management systems, enterprise collaborative services, ability, presence and location information. More particularly, the present invention provides flexibility and dynamic control over call treatment methods based on a subscriber's personal lifestyle.

In present times, communication Service Providers (CSP) are under constant pressure to improve revenues and to reduce subscriber churn. One of the problems faced by CSPs is a high number of unanswered calls. These calls result in the CSP's Call Success Rate (CSR) being impacted. Since the unsuccessful calls do not bring any revenue, low CSR amounts to low revenues.

Keeping in view that with an already high telephone density in developed economies, adding new subscribers is not a viable option. Hence, one method by which CSPs can increase revenues is by improving CSR. Another method is by improving average revenue per subscriber by adding more features and value added services (VAS) to plain voice services. Innovative VAS also brings with it customer delight factor, thereby reducing subscriber chum to competition.

Further, in present times, almost all subscribers posses more than one phones such as a home phone, a business phone and a cell phone. Multiple phones pose a challenge for the subscribers in the form of keeping track of all contact numbers as well as connecting with people amidst their busy schedules. The best a caller subscriber can do is to leave a voice message and wait for callback. It is difficult for a called subscriber to take note of all incoming calls and there is always a chance of missing out on an important call.

Consequently there is need for a system and method for increasing CSR and providing VAS to subscribers. There is also need for a system and method for providing an automated method of connecting two subscribers as per their schedules; and for providing subscribers with flexibility and dynamic control over call treatment methods based on their personal lifestyle.

### SUMMARY OF THE INVENTION

A system for providing personalized call treatment to an incoming call by using a combination of data and communication services is provided. The system comprises a Mashup application for determining a treatment method corresponding to each incoming call based on a called person's profile and one or more predefined call treatment rules. The system further comprises a communication services platform coupled with the Mashup application; the communication services platform comprising a telephone exchange module. The system yet further comprises a data services platform coupled with the Mashup application; the data services platform comprising publically available third party personal information management services and enterprise level collaborative services.

The Mashup application comprises a database for storing subscriber profiles; a database for storing predefined call treatment rules; a service manager for treating each incoming call based on the predefined call treatment rules; a rules engine for dynamically loading predefined call treatment rules corresponding to a subscriber from the database storing the rules; a web application enabling registration, profiling, configuration and rule definition; and an interactive voice response system for interacting with a caller of the incoming call.

A method for providing personalized call treatment to an incoming call by using a combination of data and communication services is also provided. The call treatment comprising performing one or more of: connecting the incoming call to a called phone number; originating/scheduling a new call to a phone number obtained by applying a set of predefined call treatment rules; diverting the call to a phone number obtained by applying a set of predefined call treatment rules; announcing a next available time slot; prompting a caller with one or more available time slots and obtaining a response through voice, text or DTMF tones from the caller; the response defining whether to schedule a meeting or search for next available slot or abandon the call; forwarding the call to voice mail; prompting caller to select a called person if called phone number is a shared number among more than one persons; converting the call from voice to text for relaying to an instant messenger for an interactive “voice-text” dialog and converting text to voice for relaying as voice call; and playing customized prompts or music or a combination of both in response to the call.

In an embodiment of the present invention the predefined call treatment rules are constructed by using one or more of: personal contact information of a subscriber obtained from either web based third party hosted contact service or an enterprise server or a handheld mobile terminal; the personal contact information comprising information such as name, company, job title, phone numbers, fax, email id, IM address, web page, residential and office addresses, manager's name, assistant's name, spouse name, birthday, anniversary, etc.; personal calendar information of a subscriber obtained from either web based third party hosted contact service or an enterprise server or a handheld mobile terminal; the personal calendar information comprising information such as one or more time slots defined in the subscriber's calendar and one or more events defined in the subscriber's calendar; enterprise address book obtained from an enterprise server; task list of a subscriber obtained from either web based third party hosted contact service or an enterprise server or a handheld mobile terminal; emails of a subscriber obtained from either web based third party hosted contact service or an enterprise server or a handheld mobile terminal; language preference and physical ability of a subscriber obtained from either web based third party hosted contact service or an enterprise server or a handheld mobile terminal; presence information of a subscriber obtained from instant messaging web servers and enterprise servers; the presence information comprising information such as presence status including but not limited to online, busy, offline, in meeting, away and do not disturb; location information of a subscriber based on the time of day rules defined by the subscriber; and time of the call.

In an embodiment of the present invention providing a personalized call treatment to an incoming call comprises the steps of: scheduling a meeting between two subscribers based on caller identity and availability of either a called subscriber or both the subscribers by utilizing personal information management systems or enterprise collaborative services; initiating a call between two subscribers based on calendar information, presence information and location information obtained from messenger services and a set of predefined rules; the location information defining whether a home phone, a business phone or a cell phone should be used for setting up the call; the presence information defining whether the call should be set up at a business phone or a cell phone, while the called subscriber is at business and whether the call should be set up at a home phone or at a cell phone, while the called subscriber is at home; diverting the call to a selected person in case a phone line is shared among multiple persons; diverting the call to a phone number at which a called subscriber is available based on identity of caller, time of call, custom forwarding number while roaming and a set of predefined rules; and automatically diverting the call to a messenger if called party is hearing or speech impaired; diverting the call comprises mapping the incoming call to an instant messenger or a office communicator and automatically converting speech to text and vice versa.

In an embodiment of the present invention, the method of the invention is provided as a computer program product comprising a computer usable medium having a computer readable program code embodied therein.

### BRIEF DESCRIPTION OF THE DRAWINGS

The present invention is described by way of embodiments illustrated in the accompanying drawings wherein:

FIG. 1 is a block diagram depicting a system for providing personalized call treatment by Mashup of communication and data sources; and

FIG. 2 illustrates an exemplary personalized call treatment scenario.

### DETAILED DESCRIPTION

A system and method for providing personalized call treatment by Mashup of data sources such as ‘Calendar’, ‘Contacts’, ‘Messenger’, ‘Email’, ‘Tasks’ and Call Web services is provided herein. Personalized call treatment is provided by delivering the incoming call on to home, business or mobile phone based on caller identity, time of call, and called party's availability. The caller identity is obtained from the called party's ‘Contacts’, and availability from ‘Calendar’. The present invention provides default features for call handling and also allows a subscriber to customize call treatment rules as per requirement.

The following disclosure is provided in order to enable a person having ordinary skill in the art to practice the invention. Exemplary embodiments are provided only for illustrative purposes and various modifications will be readily apparent to persons skilled in the art. The general principles defined herein may be applied to other embodiments and applications without departing from the spirit and scope of the invention. Also, the terminology and phraseology used is for the purpose of describing exemplary embodiments and should not be considered limiting. Thus, the present invention is to be accorded the widest scope encompassing numerous alternatives, modifications and equivalents consistent with the principles and features disclosed. For purpose of clarity, details relating to technical material that is known in the technical fields related to the invention have not been described in detail so as not to unnecessarily obscure the present invention.

The present invention would now be discussed in context of embodiments as illustrated in the accompanying drawings.

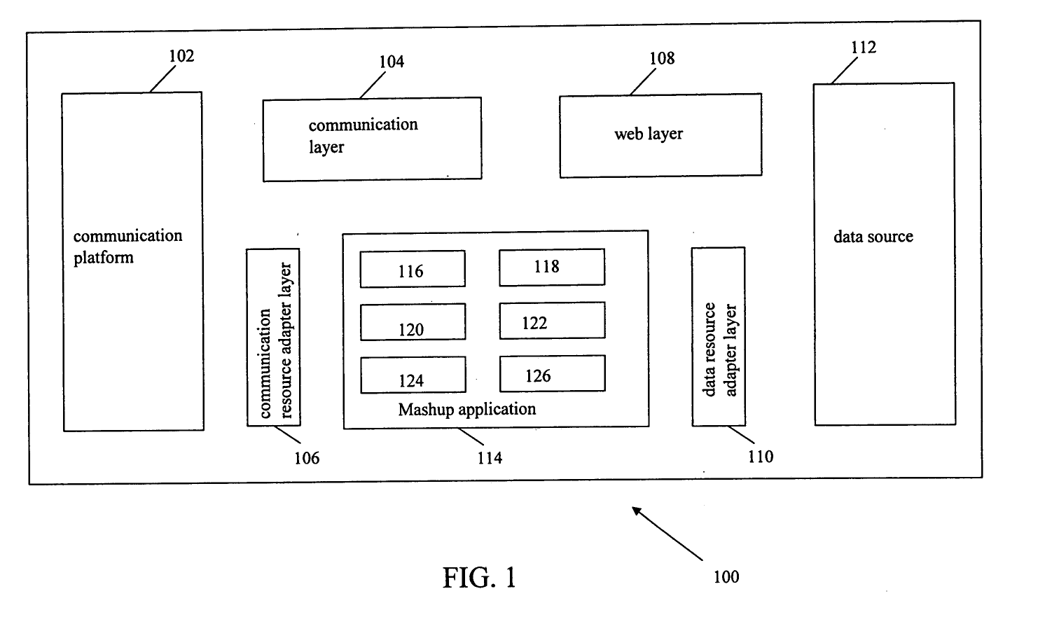

FIG. 1 is a block diagram depicting a system for providing personalized call treatment by Mashup of communication and data sources. System 100 comprises a communication platform 102, a communication layer 104, a communication resource adapter layer 106, a web layer 108, a data resource adapter layer 110, a data source 112 and a Mashup application 114.

Communication Platform 102 comprises any hardware/software providing telephone exchange features. Communication platform 102 also comprises switches used by telecom service providers such as Sylantro™ and SONUS™. In various embodiments of the present invention Mashup application 112 may be integrated with various third-party voice platform vendors. Communication Layer 104 comprises devices used for communication such as a conventional phone, a Voice over Internet Protocol (VOIP) phone, a cell phone, a Session Initiation Protocol (SIP) based soft-phone, a messenger etc.

Communication resource adapter layer 106 comprises one or more resource adapters enabling different communication platforms to be integrated with Mashup application 112. Web layer 108 comprises web clients enabling interaction of Mashup application 112 with web applications such as web-browsers. 112. Data resource adapter layer 110 comprises resource adapters for different personal information management systems and enterprise collaborative services.

Data source 112 comprises publicly available third-party personal information managements systems such as Google™ Calendar, Contacts, Gmail™, Gtalk™ (Messenger) and Tasks. Data source 112 also comprises enterprise level collaborative services like Microsoft™ Exchange and Communicator services, Lotus Notes™ or other similar service.

Mashup application 114 provides call treatment methods based on a subscriber's personal lifestyle. Mashup application 114 comprises an interactive voice response (IVR) module 116 a web application module 118, a service manager 120, a rule engine 122, a rule database 124 and a user profile database 126. IVR module 116 provides a voice interface. Web application module 118 provides an internet based interface enabling registration, profiling, configuring and defining rules. Service manager 120 manages incoming calls by treating the calls based on predefined rules. Rule engine 122 enables dynamic loading of rules corresponding to each subscriber from rule database 124. Rule database 124 stores call treatment rules corresponding to each subscriber. User profile database 126 stores profiles corresponding to each subscriber.

In an embodiment of the present invention, a meeting is scheduled between two subscribers based on caller identity and availability of either a called subscriber or both the subscribers by utilizing personal information management systems or enterprise collaborative services. The identity of the caller is ascertained by using called subscriber's address book or contacts. Availability of the called subscriber or both the subscribers is ascertained using calendar information. The caller is prompted with next available meeting time slot, utilizing either called subscriber or both the subscribers calendar information. The caller may respond via voice or dual tone multi frequency (DTMF) to schedule a meeting or search for next available time slot or abandon meeting setup. The caller is also prompted to define duration of the meeting. In case the caller does not want to define the duration, a pre-defined duration is used for meeting setup. The caller is prompted to accept meeting with chosen duration and time slot. Upon acceptance, the caller is prompted to record a meeting context message. In case a message is recorded, it is either attached or converted to text and added to a meeting invite. An email meeting invite is sent to both the subscribers. An SMS can also be sent to the called subscriber notifying meeting setup.

In an embodiment of the present invention, a call between two subscribers is initiated based on calendar information, presence and location. Presence is obtained by utilizing messenger services and location is obtained based on time of the day. The obtained location enables defining whether a home phone or a business phone or a cell phone should be used for setting up the call. The obtained presence information further enables defining whether the call should be set up at a business or a cell phone, while the subscriber is at business and whether the call should be set up at a home phone or at a cell phone, while the subscriber is at home. In an embodiment of the present invention, the location information can be obtained from global positioning system (GPS) based location services.

In an embodiment of the present invention, a call is diverted to a correct person in case a phone line is shared among multiple people. A caller is prompted with names of persons sharing the phone line by using a called number common address book or contacts. Once a caller chooses a person the call is treated as per rules defined by the chosen person.

In an embodiment of the present invention, an incoming call is diverted to a phone at which a called subscriber is available or as per call treatment rules defined by the subscriber. An incoming call is routed based on identity of the caller (family, friend, and Business), time of call custom forwarding number while roaming and the call treatment rules defined by the called subscriber. The system of the present invention sends alerts on SMS when a voice message gets deposited on any phone belonging to the subscriber or as per call treatment rules defined by the subscriber.

In an embodiment of the present invention, a caller is informed about availability of called party based on calendar information and the call treatment rules defined by the caller. The caller is informed about the free time slots available with the called party to enable the caller to choose a time for calling back. In an embodiment of the present invention, an incoming call is automatically diverted to a messenger in case the called party is hearing or speech impaired. The incoming call is mapped to instant messenger or office communicator and automatic conversion of speech to text and vice versa takes place.

In various embodiment of the present invention, an incoming call is subjected to the following call treatments:
call is connected to originally called number;
a new call is originated/scheduled to a phone number defined by using call treatment rules;
call is diverted to another phone number obtained by applying a set of predefined call treatment rules;
a next available called subscriber time slot is announced;
a next available called subscriber time slot is prompted and a response is obtained through voice, text or DTMF tones from caller defining whether to schedule a meeting or search for next available slot or abandon the call;
call is forwarded to voice mail;
if called number is a shared number among more than one persons, prompting caller to select the called person;
call is converted from voice to text conversion for relaying it as text to instant messenger for interactive “voice—text” dialog. Also, text is converted to voice to be relayed as voice call; and
customized prompts or music or combination of the two is played in response to the call.

In various embodiments of the present invention, call treatment rules for call treatment are defined by using one or more of the following information:
Personal contact information—available on either web based third party hosted contact service or on enterprise server or handheld mobile terminal. The defined call treatment rules uses information such as:
   individual contact information elements of caller and called subscriber availability in the contact service, including but not restricted to name, company, job title, phone numbers, fax, email id, IM address, web page, residential & office addresses, manager's name, assistant's name, spouse name, birthday, anniversary, etc.
   group a subscriber is defined as a part of in called subscriber's contact list. The groups could be personalized and customized by called subscriber, including but not restricted to friends, family members, co-workers, business associates, vendors, suppliers, customers, VIPs, etc.
   Any other new information element made available by contact service application provider on web or enterprise contact server.
Personal Calendar information—available on either web based third party hosted contact service or on enterprise server or handheld mobile terminal. The defined call treatment rules uses information such as:
   Information tags about various time slots defined in the calendar, including but not restricted to free, busy, tentative, out of office, etc.
   Information elements about calendar events, including but not restricted to important, business, personal, vacation, must attend; travel required, needs preparation, birthday, anniversary, phone call, etc.
   Any other new information element made available by calendar service application provider on web or enterprise calendar server.
Enterprise address book—available on enterprise server.
Task list-available on either web based third party hosted service or on enterprise server or handheld mobile terminal. The defined call treatment rules uses information such as:
   Information elements about task list, including but not restricted to subject, importance tag, status, percentage completion, category, etc.
   Any other new information element made available by the service application provider on web or enterprise server.
E-mail-available on either web based third party hosted contact service or on enterprise server. The defined call treatment rules uses information such as:
   Information elements of inbox/outbox/sent/draft/deleted emails including but not restricted to from, to, header status, importance, flag status, attachment, subject, received, sent, size, category, cc, bcc, created, message, signatures and originator delivery requested.
   Any other new information element made available by the service application provider on web or enterprise server.
Ability of calling, called and forwarded subscriber—information available on web server or enterprise server. The defined call treatment rules uses information such as:
   Information about physical ability of calling called or forwarded subscriber including but not restricted to normal, hearing impaired, deaf and dumb, visually impaired, etc.;
   Language preference or ability;
Presence—information available on Instant messaging web servers and enterprise servers. The defined call treatment rules uses information such as:
   Presence status including but not limited to online, busy, offline, in meeting, away and do not disturb;
   Any other new information element made available by the service application provider on web or enterprise server;.
   Information elements made available by telecom networks in future.
Location—location information is based on the time of day rules defined by subscriber; and
Time of call.

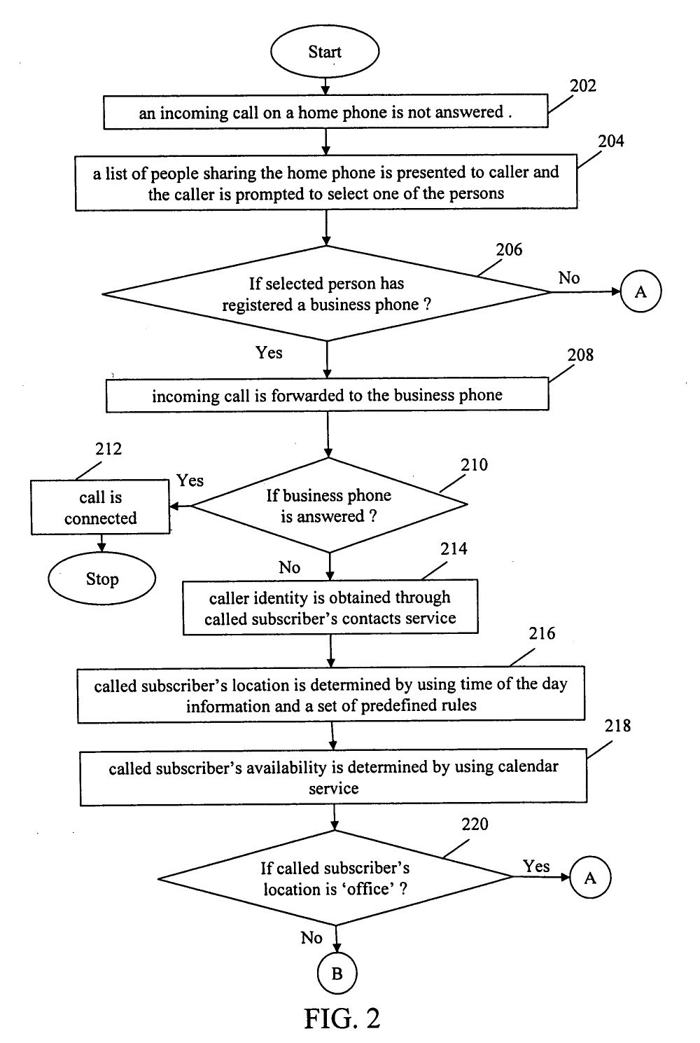

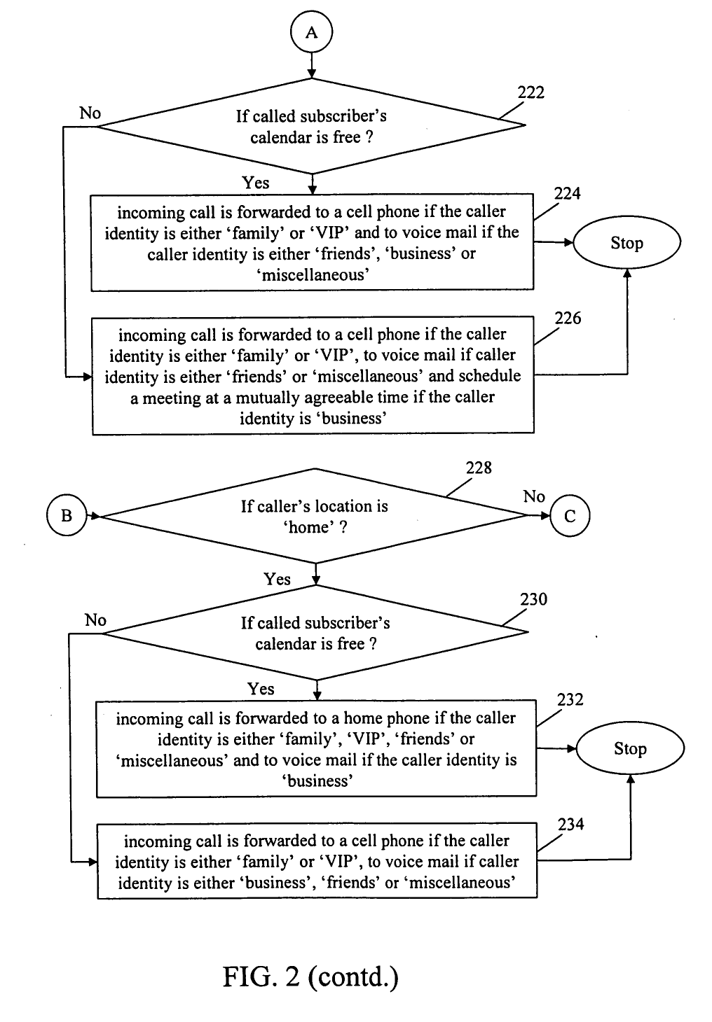

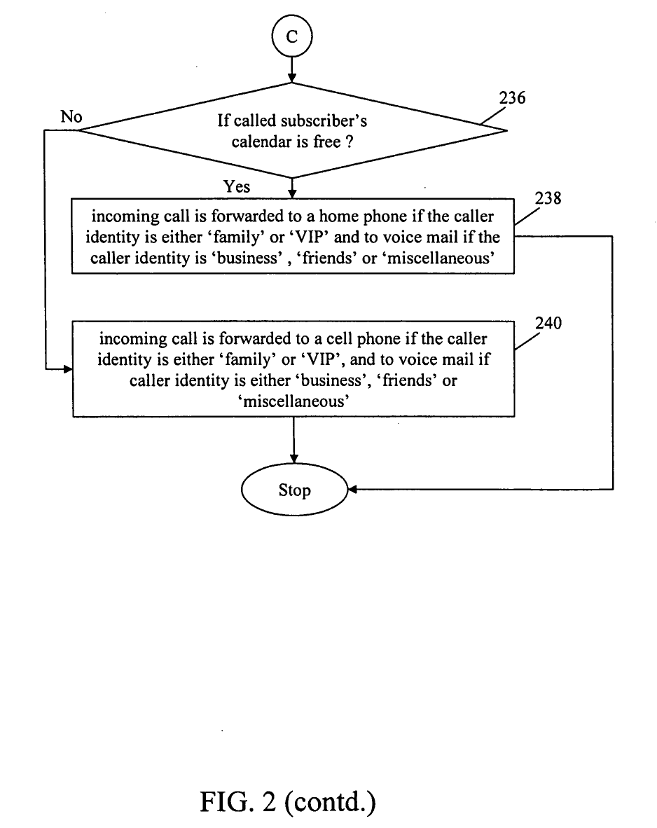

FIG. 2 illustrates an exemplary personalized call treatment scenario. At step 202, an incoming call on a home phone is not answered. At step 204 a list of people sharing the home phone is presented to caller and the caller is prompted to select one of the persons sharing the home phone. At step 206 it is determined whether the selected person has registered a business phone. If the caller has defined a business phone the incoming call is forwarded to the business phone at step 208. At step 210 it is determined whether the business phone is answered. If the business phone is answered the caller is connected to the called person at step 212.

If the business phone is not answered, at step 214 caller identity is obtained through called subscriber's contacts service. At step 216 called subscriber's location is determined by using time of the day information and a set of predefined rules. In an embodiment of the present invention, the called subscriber's office and home timings are established based on profile information or call treatment rules defined by the subscriber. At step 218, the called subscriber's availability is determined by using calendar service. At step 220 it is determined if called subscriber's location is ‘office’. At step 222 if the subscriber's location is determined as office, it is determined if the called subscriber's calendar is free. At step 224 if the called subscriber's calendar is free, the incoming call is forwarded to a cell phone if the caller identity is either ‘family’ or ‘VIP’ and to voice mail if the caller identity is either ‘friends’, ‘business’ or ‘miscellaneous’. If the called subscriber's calendar is busy then at step 226, the incoming call is forwarded to a cell phone if the caller identity is either ‘family’ or ‘VIP’, to voice mail if caller identity is either ‘friends’ or ‘miscellaneous’ and schedule a meeting at a mutually agreeable time if the caller identity is ‘business’.

If it is determined that called subscriber's location is not ‘office’ at step 220, then at step 228 it is determined if the caller's location is ‘home’. At step 230 it is determined if the called subscriber's calendar is free. If the called subscriber's calendar is free, then at step 232, the incoming call is forwarded to a home phone if the caller identity is either ‘family’, ‘VIP’, ‘friends’ or ‘miscellaneous’ and to voice mail if the caller identity is ‘business’. If the called subscriber's calendar is busy then at step 234, the incoming call is forwarded to a cell phone if the caller identity is either ‘family’ or ‘VIP’, to voice mail if caller identity is either ‘business’, ‘friends’ or ‘miscellaneous’.

If it is determined that called subscriber's location is not ‘home’ at step 228, then at step 236 it is determined if the called subscriber's calendar is free. If the called subscriber's calendar is free, then at step 238, the incoming call is forwarded to a home phone if the caller identity is either ‘family’ or ‘VIP’ and to voice mail if the caller identity is ‘business’, ‘friends’ or ‘miscellaneous’. If the called subscriber's calendar is busy then at step 240, the incoming call is forwarded to a cell phone if the caller identity is either ‘family’ or ‘VIP’, and to voice mail if caller identity is either ‘business’, ‘friends’ or ‘miscellaneous’.

In various embodiments of the present invention the flow of steps as illustrated in FIG. 2 may be modified in accordance with rules defined by a subscriber.

The present invention may be deployed by a communication services Provider (CSP). In case of such deployment the CSP owns and manages both a voice services platform and a Mashup application platform. Data Sources that are used comprises web hosted services being managed by third party application providers, which services are being used by subscribers, thus seamlessly blending into subscriber lifestyle.

The present invention may also be deployed by a third party application provider. In case of such deployment the third party application provider owns and manages Mashup application platform and ties up with one or more CSPs to obtain access to web and call services. Data Sources that are used comprise web hosted services being managed by third party application providers, which services are being used by subscribers, thus seamlessly blending into subscriber lifestyle.

The present invention may also be deployed in an enterprise. In such a deployment scenario, data sources and voice services platform (PBX, IP PBX or VOIP switch) as well as Mashup application platform are owned and managed by the enterprise itself. Data Sources that are used comprise enterprise collaborative services such as Microsoft Exchange or Lotus Notes.

While the exemplary embodiments of the present invention are described and illustrated herein, it will be appreciated that they are merely illustrative. It will be understood by those skilled in the art that various changes in form and detail may be made therein without departing from or offending the spirit and scope of the invention as defined by the appended claims.

1. A system for providing personalized call treatment to an incoming call by using a combination of data and communication services, the system comprising a Mashup application for determining a treatment method corresponding to each incoming call based on a called person's profile and one or more predefined rules.

2. The system as claimed in claim 1 further comprising a communication services platform coupled with the Mashup application; the communication services platform comprising a telephone exchange module.

3. The system as claimed in claim 1 further comprising a data services platform coupled with the Mashup application; the data services platform comprising publically available third party personal information management services.

4. The system as claimed in claim 3 further comprising enterprise level collaborative services.

5. The system as claimed in claim 1 wherein the Mashup application comprises:
a. a database for storing subscriber profiles;
b. a database for storing predefined call treatment rules;
c. a service manager for treating each incoming call based on the predefined call treatment rules;
d. a rules engine for dynamically loading predefined call treatment rules corresponding to a subscriber from the database storing the rules;
e. a web application enabling registration, profiling, configuration and rule definition; and
f. an interactive voice response system for interacting with a caller of the incoming call.

6. A method for providing personalized call treatment to an incoming call by using a combination of data and communication services; the call treatment comprising performing one or more of:
a. connecting the incoming call to a called phone number;
b. originating/scheduling a new call to a phone number obtained by applying a set of predefined call treatment rules;
c. diverting the call to a phone number obtained by applying a set of predefined call treatment rules;
d. announcing a next available time slot;
e. prompting a caller with one or more available time slots and obtaining a response through voice, text or DTMF tones from the caller; the response defining whether to schedule a meeting or search for next available slot or abandon the call;
f. forwarding the call to voice mail;
g. prompting caller to select a called person if called phone number is a shared number among more than one persons;
h. converting the call from voice to text for relaying to an instant messenger for an interactive “voice—text” dialog and converting text to voice for relaying as voice call; and
i. playing customized prompts or music or a combination of both in response to the call.

7. The method as claimed in claim 6 wherein the predefined call treatment rules are constructed by using one or more of:
a. personal contact information of a subscriber obtained from either web based third party hosted contact service or an enterprise server or a handheld mobile terminal; the personal contact information comprising information such as name, company, job title, phone numbers, fax, email id, IM address, web page, residential and office addresses, manager's name, assistant's name, spouse name, birthday, anniversary, etc.
b. personal calendar information of a subscriber obtained from either web based third party hosted contact service or an enterprise server or a handheld mobile terminal; the personal calendar information comprising information such as one or more time slots defined in the subscriber's calendar and one or more events defined in the subscriber's calendar;
c. enterprise address book obtained from an enterprise server;
d. task list of a subscriber obtained from either web based third party hosted contact service or an enterprise server or a handheld mobile terminal;
e. emails of a subscriber obtained from either web based third party hosted contact service or an enterprise server or a handheld mobile terminal;
f. language preference and physical ability of a subscriber obtained from either web based third party hosted contact service or an enterprise server or a handheld mobile terminal;
g. presence information of a subscriber obtained from instant messaging web servers and enterprise servers; the presence information comprising information such as presence status including but not limited to online, busy, offline, in meeting, away and do not disturb;
h. location information of a subscriber based on the time of day rules defined by the subscriber; and
i. time of the call.

8. The method as claimed in claim 6 wherein providing a personalized call treatment to an incoming call comprises the steps of:
a. scheduling a meeting between two subscribers based on caller identity and availability of either a called subscriber or both the subscribers by utilizing personal information management systems or enterprise collaborative services;
b. initiating a call between two subscribers based on calendar information, presence information and location information obtained from messenger services and a set of predefined rules; the location information defining whether a home phone, a business phone or a cell phone should be used for setting up the call; the presence information defining whether the call should be set up at a business phone or a cell phone, while the called subscriber is at business and whether the call should be set up at a home phone or at a cell phone, while the called subscriber is at home;
c. diverting the call to a selected person in case a phone line is shared among multiple persons;
d. diverting the call to a phone number at which a called subscriber is available based on identity of caller, time of call, custom forwarding number while roaming and a set of predefined rules; and
e. automatically diverting the call to a messenger if called party is hearing or speech impaired; diverting the call comprises mapping the incoming call to an instant messenger or a office communicator and automatically converting speech to text and vice versa.

9. A computer program product comprising a computer usable medium having a computer readable program code embodied therein for providing personalized call treatment to an incoming call by using a combination of data and communication services, the computer program product comprising one or more of:
a. program instruction means for connecting the incoming call to a called phone number;
b. program instruction means for originating/scheduling a new call to a phone number obtained by applying a set of predefined call treatment rules;
c. program instruction means for diverting the call to a phone number obtained by applying a set of predefined call treatment rules;
d. program instruction means for announcing a next available time slot;
e. program instruction means for prompting a caller with one or more available time slots and obtaining a response through voice, text or DTMF tones from the caller; the response defining whether to schedule a meeting or search for next available slot or abandon the call;
f. program instruction means for forwarding the call to voice mail;
g. program instruction means for prompting caller to select a called person if called phone number is a shared number among more than one persons;
h. program instruction means for converting the call from voice to text for relaying to an instant messenger for an interactive “voice—text” dialog and converting text to voice for relaying as voice call; and i. program instruction means for playing customized prompts or music or a combination of both in response to the call.

10. The computer program product as claimed in claim 9 wherein the predefined call treatment rules are constructed by using one or more of:
a. personal contact information of a subscriber obtained from either web based third party hosted contact service or an enterprise server or a handheld mobile terminal; the personal contact information comprising information such as name, company, job title, phone numbers, fax, email id, IM address, web page, residential and office addresses, manager's name, assistant's name, spouse name, birthday, anniversary, etc.
b. personal calendar information of a subscriber obtained from either web based third party hosted contact service or an enterprise server or a handheld mobile terminal; the personal calendar information comprising information such as one or more time slots defined in the subscriber's calendar and one or more events defined in the subscriber's calendar;
c. enterprise address book obtained from an enterprise server;
d. task list of a subscriber obtained from either web based third party hosted contact service or an enterprise server or a handheld mobile terminal;
e. emails of a subscriber obtained from either web based third party hosted contact service or an enterprise server or a handheld mobile terminal;
f. language preference and physical ability of a subscriber obtained from either web based third party hosted contact service or an enterprise server or a handheld mobile terminal;
g. presence information of a subscriber obtained from instant messaging web servers and enterprise servers; the presence information comprising information such as presence status including but not limited to online, busy, offline, in meeting, away and do not disturb;
h. location information of a subscriber based on the time of day rules defined by the subscriber; and
i. time of the call.

11. The computer program product as claimed in claim 9 wherein the program instruction means providing a personalized call treatment to an incoming call comprises:
a. program instruction means for scheduling a meeting between two subscribers based on caller identity and availability of either a called subscriber or both the subscribers by utilizing personal information management systems or enterprise collaborative services;
b. program instruction means for initiating a call between two subscribers based on calendar information, presence information and location information obtained from messenger services and a set of predefined rules; the location information defining whether a home phone, a business phone or a cell phone should be used for setting up the call; the presence information defining whether the call should be set up at a business phone or a cell phone, while the called subscriber is at business and whether the call should be set up at a home phone or at a cell phone, while the called subscriber is at home;
c. program instruction means for diverting the call to a selected person in case a phone line is shared among multiple persons;
d. program instruction means for diverting the call to a phone number at which a called subscriber is available based on identity of caller, time of call, custom forwarding number while roaming and a set of predefined rules; and
e. program instruction means for automatically diverting the call to a messenger if called party is hearing or speech impaired; diverting the call comprises mapping the incoming call to an instant messenger or a office communicator and automatically converting speech to text and vice versa.
